(19) United States
(12) Patent Application Publication
(10) Pub. No.: US 2024/0085543 A1
(43) Pub. Date: Mar. 14, 2024

(54) MEASURING APPARATUS AND METHOD FOR MEASURING ELECTROMAGNETIC WAVES

(71) Applicant: MECORAD GMBH, Chemnitz (DE)

(72) Inventors: Marc BANASZAK, Dusseldorf (DE); Andreas HEUTZ, Bornheim (DE); Cagdas ÜNLÜER, Essen (DE)

(21) Appl. No.: 18/261,719

(22) PCT Filed: Jan. 18, 2022
(86) PCT No.: PCT/EP2022/051044

§ 371 Date: Jul. 17, 2023

(30) Foreign Application Priority Data
Jan. 18, 2021 (LU) LU102493

(51) Int. Cl. G01S 7/52; G01S 7/02; G01S 7/40

(52) U.S. Cl. CPC G01S 7/52006; G01S 7/027; G01S 7/4008; G01S 7/4021

(57) ABSTRACT

The invention relates to a measuring device for electromagnetic waves, in particular a radar apparatus, for a measurement of a measure, in particular a distance, in particular a distance of one or more objects to be measured, and/or a signal intensity, in particular a signal intensity correlating with a size and/or quantity of one or more objects to be measured, with compensation of a drift behavior, in particular a temperature-dependent drift behavior, comprising a housing, in particular a hermetically sealed off and/or lockable housing, a sensor and/or receiver for electromagnetic waves which is/are which is/are arranged in the housing, in particular a receiver for electromagnetic waves in the radio frequency range, which comprises, in particular, an oscillator, a detection device, which is arranged in the housing, for detecting at least one physical parameter, in particular a physical parameter of the environment, in particular a temperature, in particular an ambient temperature, in particular a temperature of an ambient air in the housing, and/or a current oscillation frequency and/or natural frequency of an oscillator, in particular an oscillator, frequency generator and/or oscillation crystal of the sensor or receiver.

The invention further relates to a method for measuring a measure, in particular a distance, in particular a distance of one or more objects to be measured, and/or a signal intensity, in particular a signal intensity correlating with a size and/or quantity of one or more objects to be measured, with compensation of a drift behavior, in particular a temperature-dependent drift behavior, in particular using a measuring device for electromagnetic waves, further in particular a radar apparatus, at least comprising the following steps:
a detection of at least one physical parameter in a housing, in particular a hermetically sealed and/or lockable housing, in which a sensor and/or receiver for electromagnetic waves is arranged, wherein the at least one physical parameter comprises a physical parameter of the environment, in particular a temperature, in particular an ambient temperature, in particular a temperature of an ambient air in the housing, and/or a current oscillation frequency and/or natural frequency of an oscillator, in particular an oscillator of the sensor or receiver for electromagnetic waves;
obtaining, in particular calculating or reading from a database, a compensation and/or compensation function and/or a compensation factor on the basis of the at least one physical parameter, in particular a compensation and/or compensation function, which is suitable for compensating, on the basis of the at least one physical parameter, a measuring error caused by an environmental parameter and/or an environmental factor on a measurement result which is based at least in part on a sensor and/or receiver for electromagnetic waves.

### TECHNICAL FIELD

The present invention relates to the technical field of metrology, and more particularly to a measuring device and method for measuring electromagnetic waves.

### STATE OF THE ART

Radar Technology

Radar (radio detection and ranging) is the name for various positioning methods and devices. This technology is based on electromagnetic waves in the radio frequency range. A radar device usually comprises three components: a radar antenna, a radar transmitter and a radar receiver. The radar antenna is used to align the transmitted pulses and to focus the impulse responses. The radar transmitter sends an electromagnetic pulse. The receiver waits for the signal response, which is generated at an object as an echo of the impulse.

The elapsed time, in particular the time elapsed between the transmission and reception of the signal, also referred to as the signal propagation time, is used to infer the distance to the object, for example. The frequencies used range from 30 MHz to 300 GHz [rad]. With the latest radar technology, an accuracy of less than one micrometer is currently possible [Sche].

A distinction is made between pulse radar and continuous wave radar, the former calculating the distance from the signal propagation time. Continuous wave radar transmits a continuous pulse width modulated signal and calculates the distance from the frequency shift between the outgoing signal and the incoming response signal.

Hermetic Sealing

In the technical sense, hermetic sealing is understood to mean an almost tight, ideally absolutely tight, seal. This can prevent the exchange of air or water, for example [Wiki].

With regard to sensor technology, sealing against water or other liquids is primarily desired. If water penetrates a sensor, the functionality is usually no longer given. One possibility for hermetic sealing is to fill or sheath sensors with gel so that there are no cavities [Mic][Brown]. Many applications of such a process are found in temperature and pressure sensors. (Temperature: Omega RTD Sensor [Omega], Krohne, Sauermann Wika [Dir], Pressure: Kavlico High Pressure Sensor [Kav]).

With regard to radar technology, a device from Hitachi is disclosed in which the cavities in the radar are filled with resin [Tosh03]. The Fraunhofer Gesellschaft zur Förderung der angewandten Forschung e.V. applied for a patent on a hermetic sealed module unit with integrated antennas [Fra]. Here, the sealing (apparently) serves to protect the internal components, possibly with cavities.

More Hermetic Sealed Off Antennas:
U.S. Pat. No. 6,243,040B1; Hermetic package with external path antenna and associated method [Corey].
U.S. Pat. No. 6,236,366B1; Hermetically sealed semiconductor module composed of semiconductor integrated circuit and antenna element [Yama].
EU Pat. No. 1357395B1; radar sensor [Tosh07].
U.S. Pat. No. 7,180,440B2; Integrated circuit for a radar device in a hermetically sealed housing comprising a patch antenna formed from a bent component of sheet metal [Sch].

These approaches of hermetic sealing are primarily used to protect the components, especially to protect them from water.

Drift Compensation

Patent U.S. Pat. No. 4,435,712 presents a radar with drift compensation. (This achieves a comparison with the measurement of a known length measurement). [Kipp] Other radar systems which include drift compensation:
U.S. Pat. No. 4,106,020; FM-CW radar ranging system [John]
CA Pat. No. 2483971; U.S. Pat. No. 7,209,072B2; Method for drift compensation with radar measurements with the aid of reference radar signals [Brau].
EP No. 1065518; High-resolution synthetic aperture radar system [Runge].
Oscillator Clock Drift Compensation on Bistatic interferometric SAR [Ein].

Rather, the examples of radar technology related to drift compensation provided herein all use or require a comparative measurement whose distance is known.

In U.S. Pat. No. 7,180,440 B2, the term hermetic sealing is used for the spatial separation of a radar antenna and a calculation unit. The modules are still exposed to environmental factors, only the mutual influence is reduced.

In EP Pat. No. 1357395 B1, the radar antenna and the calculation unit are also spatially separated from each other. Here, the effect of hermetic sealing is enhanced by the enclosure of the electrical components with resin. This makes it more difficult to condition the environment/material surrounding the parts.

Furthermore, an imaging and pattern recognition method based on millimeter-wave radar is known from patent specification CN108896989A. In a first step, the method comprises the creation of measuring data at a reference temperature and reference humidity. In a further step, the method comprises the creation of measuring data at temperatures and/or humidity values deviating from the reference temperature and humidity. Subsequently, in a further step, the influence of the temperature and humidity fluctuation on the measurement is analyzed and influencing factors on the imaging are determined using millimeter-wave radar by a training system (for example, in the form of a computer program product or artificial intelligence). In the following step, the obtained measuring data are corrected according to the calculated influencing factors. In a final step, the radar image thus obtained is combined with the measuring data from a high-resolutioned thermal imaging technique to obtain a final measuring result.

Although the patent specification discloses an imaging technique in which the measuring result is corrected according to a set of influencing factors such that the influence of variations in temperature and humidity is corrected, the measuring device used in the technique is not a measuring device in a hermetically sealed off housing. Thus, the method and the measuring device are not robust to extreme environmental factors, such as extreme heat and/or dirt exposure, or dust exposure.

Furthermore, although the temperature is measured by means of a temperature sensor which can be mounted on the outer or inner wall of the housing surrounding the measuring device, only a punctual measurement of the temperature is carried out in the patent specification. Possible temperature fluctuations, or an uneven temperature distribution around the transmitter and/or receiver of the measuring device is not taken into account in the compensation, nor is heating up of the housing, which can provide for falsified temperature readings.

Patent CN109343054A discloses an apparatus for an imaging technique using radar, wherein the imaging is performed through-wall. Disclosed herein is an apparatus comprising a main board, an antenna, a power amplifier, a grid mechanism, and a driver, wherein the antenna is mounted on and connected to the amplifier, and wherein the power amplifier is connected to the main board. The device is adapted to provide imaging through a wall.

Further, it may include a housing configured to include openings for passing cables therethrough and for cooling purposes. Additionally, active cooling may be provided in the form of heat dissipating members, such as a fan.

Also in this execution it is to be mentioned however disadvantageously that the measuring device is not suitable for the direct employment in areas with high heat and/or dirt exposure, and/or dust exposure, since the housing cannot protect the sensitive construction elements and circuit elements contained in it against high temperatures and dirt by the openings. The built-in ventilation elements can also no longer perform their cooling function once a certain temperature is exceeded, since convection to restrict the built-in electronic components is only possible at ambient temperatures below the critical temperature for the components, at which they are damaged and/or can only function to a limited extent.

In addition, this patent document does not take into account the influence of high temperatures on a measurement. Thus, deviations in the measurement may occur when using this method in areas with high environmental load.

### Task

Thus, it is the task of the present invention to provide a device and a method which enables accurate measurements by means of modern radar technology which compensate for changes in ambient conditions, in particular changes in ambient temperature, humidity, oscillation frequency of an oscillating crystal or supply voltage.

Furthermore, it is the task of the invention to provide a device and a method which are robust against extreme environmental factors, for example high heat or dust exposure in the environment of the device, and which offer sufficient protection against destruction of the measuring equipment.

### Solution

The task is solved by the device according to claim 1. Claim 1 discloses a measuring device for electromagnetic waves, in particular radar apparatus, for a measurement of a measure, in particular a distance, in particular a distance of one or more objects to be measured, and/or a signal intensity, in particular signal intensity correlating with a size and/or quantity of one or more objects to be measured, comprising compensation of a drift behavior, in particular a temperature dependent drift behavior:
a hermetic sealed off and/or lockable housing (1, 2, 11, 12),
a sensor and/or receiver (4) for electromagnetic waves, which is arranged in the hermetically sealed off and/or lockable housing (1, 2, 11, 12), comprising an oscillator, in particular a receiver for electromagnetic waves in the radio frequency range,
a detection device (5), characterized in that it is arranged in the hermetically sealed off and/or lockable housing (1, 2, 11, 12), wherein the detection device is set up for detecting
   at least one physical parameter, in particular a physical parameter of the environment, in particular a temperature, in particular an ambient temperature, in particular a temperature of an ambient air in the housing (1, 2, 11, 12), and/or
   of a current oscillation frequency and/or natural frequency of an oscillator, in particular an oscillator, frequency generator and/or oscillating crystal of the sensor or receiver (4).

Further advantageous embodiments can be found in the subclaims, the description and the embodiment examples.

### General Advantages

The present invention advantageously enables the use of modern radar technology in areas in which, due to environmental factors, measurement by means of a radar apparatus is not possible or is possible only with difficulty and with a loss of measurement accuracy.

Furthermore, the measurement accuracy is significantly increased by the device according to the invention and the method according to the invention compared to conventional measurement methods and can thus be decoupled from the environmental factors present at the time of measurement.

The device according to the invention and the method according to the invention thus provide a possibility for precise and low-effort location of objects in a space by means of radar technology, which can be used in many technical fields, for example, but not exclusively, in the manufacturing industry for monitoring production steps and tolerances, in logistics or in the automotive field.

In addition, hermetic sealing in the sense of the invention offers the advantage that it can protect the components of the radar apparatus not only from high temperatures but also from the ingress of external factors, in particular dirt or dust exposure.

### DETAILED DESCRIPTION OF THE INVENTION

The invention comprises a measuring device which is suitable for low interference and precise measurement of distances by means of electromagnetic waves, is hermetically sealed and is equipped with drift compensation. In particular, a radar unit is used for transmission and measurement of the electromagnetic waves. Radar units, which operate for example according to the FM-CW principle (frequency modulated continuous wave, continuous wave radar), are subject to environmental factors, for example air temperature, air pressure and air humidity, as well as aging of the components, which have an influence on the measurement result. The deviations have a particular influence on measurement processes with a demand for high quality.

The measuring device is designed in particular for a measurement of a distance of an object under compensation of a drift behavior, in particular a temperature-dependent drift behavior, wherein in particular a measured distance and/or a frequency measured for the purpose of determining the distance is compensated.

In a further embodiment, the measuring device is arranged to measure a signal intensity, wherein the signal intensity correlates with a size and/or quantity of one or more objects and/or with a size and/or area of a surface facing the sensor or receiving device, with compensation of a drift behavior in said signal intensity, in particular a temperature-dependent drift behavior in said signal intensity, wherein in particular a measured signal intensity and/or a measured size and/or quantity of one or more objects and/or an area of a surface facing the sensor or receiving device is compensated.

The measuring device according to the invention further comprises a housing comprising a material suitable for protecting against an effect of an electromagnetic radiation in the infrared range on the measuring device, in particular suitable for absorbing and/or reflecting but hardly transmitting an electromagnetic radiation in the infrared range or in the heat radiation range, respectively.

In the present invention, the hermetic sealing is intended to prevent, for example, the exchange of gas, in particular the exchange of air surrounding the parts, as well as the penetration of irradiation into the module housing, in particular infrared radiation for heat transfer. For example, seals, in particular one or more seals between the housing front panel and the housing body, as well as between the housing body and the housing cover, can be used for sealing the housing.

Another possible use of hermetic sealing is, for example, the creation of a (partial) vacuum inside the housing so that little or no heat convection is possible between the modules. In another embodiment, the inner cavity could be filled with a protective gas atmosphere that impedes heat transfer between the modules and/or facilitates heat dissipation therefrom.

A (partial) vacuum is in particular any gas pressure that is less than 1 atm.

For the purposes of the invention, a (partial) vacuum also refers to an enclosed area in which negative pressure prevails.

Another possibility of using hermetic sealing is when there is an overpressure inside the housing. In this case, an overpressure is regularly greater than 1 atm.

The present embodiment of a radar unit consists of a transmitter and receiver, which are designed as a transceiver unit, for electromagnetic waves according to the FM-CW principle, in particular for waves in the radio frequency range. The radar unit is connected to a calculation unit (microcontroller, single-board computer or similar). The radar unit includes an oscillator for radio wave generation and radio wave reception in the radio frequency range.

In the sense of the invention, transceiver unit refers to a radar apparatus in which the transmitter and/or emitter of electromagnetic waves, in particular the transmitter and/or emitter of electromagnetic waves in the radio frequency range, and the receiver and/or sensor of electromagnetic waves, in particular the receiver and/or sensor of electromagnetic waves in the radio frequency range, are realized in a singular unit, particularly preferably at least one antenna.

In another embodiment, the transmitter and/or emitter and the receiver and/or sensor of the radar unit are present in two separate units, particularly preferably at least two antennas.

According to one embodiment, the measuring device according to the invention further comprises an electromagnetic wave transmitter and/or emitter, which is different from the electromagnetic wave sensor and/or receiver and is set up to emit a signal in the form of an electromagnetic wave, in particular in the form of an electromagnetic wave in the radio frequency range, and/or whose electromagnetic wave sensor and/or receiver is furthermore set up as a transmitter and/or emitter, in particular as a transceiver.

Further, in one embodiment, the measuring device may comprise an electromagnetic wave transmitter and/or emitter different from the electromagnetic wave sensor and/or receiver and adapted to emit a signal in the form of an electromagnetic wave, in particular in the form of an electromagnetic wave in the radio frequency range, the measuring device further comprising:
a housing of the transmitter, in particular a hermetically sealed off and/or lockable housing of the transmitter, wherein the transmitter and/or emitter for electromagnetic waves is arranged in the housing of the transmitter, in particular transmitter and/or emitter for electromagnetic waves in the radio frequency range, which in particular comprises an oscillator, in particular an oscillator, frequency generator and/or oscillating crystal
a detection device of the transmitter, which is arranged in the housing of the transmitter, for detecting at least one physical parameter in the housing of the transmitter, in particular a physical parameter of the environment, in particular a temperature, in particular an ambient temperature, in particular a temperature of an ambient air in the housing of the transmitter, and/or a current oscillation and/or natural frequency of an oscillator of the transmitter, in particular of an oscillator, frequency generator and/or oscillating crystal of the transmitter, the measuring device being set up to perform drift compensation on the basis of the physical parameter in the housing of the transmitter, with compensation being carried out in particular on the receiver side on the received signal on the basis of the physical parameter in the housing of the transmitter.

For the purposes of the invention, the term antenna refers to a technical arrangement for transmitting and/or receiving electromagnetic waves, in particular electromagnetic waves in the radio frequency range. The device according to the invention comprises at least one antenna for transmitting and receiving electromagnetic waves, in particular electromagnetic waves in the radio frequency range. Embodiments with two, three, four or any other number of antennas are also possible.

The advantages of hermetic sealing are that the atmosphere immediately surrounding the calculation unit and the radar frontend is not in direct communication with the environment surrounding the measuring equipment. This in turn means that the influencing factors on the measuring components and computing components can be kept more constant.

For the purposes of the invention, constant influencing factors on the measuring components and computing components are understood to mean that the environmental factors surrounding them, in particular the temperature, humidity and pressure, remain unchanged or largely unchanged over a long period of time, in particular a period of time much longer than the time taken to perform a measurement.

The measuring device further comprises a calculation unit which is set up to compensate for drift behavior or to take it into account by calculation, in particular by means of a digital circuit and/or by means of an analog circuit.

The calculation unit comprised by the device according to the invention is arranged, for example, inside the housing. For the purposes of the invention, a calculation unit means a computing system comprising a processor unit for executing and processing program commands, a communication interface for receiving and transmitting data, and a computer readable storage medium, wherein the computer readable storage medium includes a computer program product, also software product.

The communication interface for transmitting and receiving data is set up in such a way that it enables data communication between the calculation unit and the radar unit, and between the calculation unit and at least one detection unit, in particular a detection unit for detecting the temperature, humidity or supply voltage, which is arranged inside the housing. The data communication here preferably runs via a physical interface, in particular a cable.

In a further embodiment, the data communication interface is set up in such a way that it enables wireless data communication between a spatially remote computing system, in particular a computing system arranged outside the housing, and the calculation unit. Thus, an exchange of data as well as an exchange of control commands between the calculation unit and the remote computing system can be realized.

The calculation unit is set up to compensate for the drift behavior or to take it into account by calculation on the basis of a detected physical parameter of the environment and/or a current oscillation frequency and/or natural frequency of an oscillator, in particular an oscillator, frequency generator and/or oscillating crystal of the sensor or receiver, in particular on the basis of a combination of at least one detected physical parameter and a current oscillation frequency and/or natural frequency of an oscillator, in particular thereby an ambient temperature and a detected current oscillation frequency and/or natural frequency of the sensor or receiver.

Furthermore, the calculation unit is set up to take into account a temporal development and/or tendency, in particular a temperature development, in particular by temporal extrapolation, when compensating or calculating.

The calculation unit records physical measures by means of at least one detection unit or detection device, for example another sensor. In this case, the recorded physical variable can be, for example, the temperature, which has an effect on the functionality of the radar unit. A temperature sensor records the temperature in the module housing and passes it on to the calculation unit.

Advantageously, recording the temperature inside the module housing ensures particularly accurate determination of the temperature at the radar unit. Thus, using the temperature measured in this way for subsequent drift compensation is favorable with regard to the accuracy of the measurement.

The detection device is arranged to have a capacitor, in particular a polymer capacitor, and/or a thermoelement and/or a thermal imaging camera and/or a variable resistor, individually or in combination, in particular in a combination of two or more thereof, as a measuring element for a physical parameter, in particular a temperature.

Furthermore, the detection device is set up to detect a temperature and/or an air humidity, in particular relative air humidity, as physical parameters.

Due to the hermetic sealing of the housing, the temperature measured in this way is particularly accurate and precise. In particular, the temperature measured in this way corresponds to the temperature of the radar unit in a particularly good approximation.

To a particularly good approximation means here that the temperature measured by a detection unit is equal to the temperature of the radar unit or deviates from it only slightly, for example by only a few tenths of a degree, such as in a range from 0.01° C. to 0.60° C., particularly preferably in a range from 0.01° C. to 0.25° C., especially hundredths of a degree, such as in a range from 0.01° C. to 0.10° C., particularly preferably in a range from 0.01° C. to 0.07° C.

A further measurement of the immediate temperature of the calculation unit can, for example, additionally take place via the temperature sensor integrated in most processors.

In one embodiment, a sensor can be applied for recording physical quantities, where the physical quantity is the pressure in the cavity of the measuring instrument. In this case, a pressure sensor measures the pressure of the air or other gas inside the module housing and passes the measure to the calculation unit.

In one embodiment, the at least one physical parameter comprises a pressure, in particular an air or gas pressure inside the housing and/or a statement about a composition or components of the air or gas inside the housing.

In one embodiment, the calculation unit or the detection unit may measure or determine the current oscillator frequency of the radar unit, for example by means of a sensor, based on a measurement and use it to calculate the drift compensation. These physical parameters change over time and therefore have a variable influence on the measurement. By taking these physical parameters into account, the drift compensation function can always adapt the measured signal to the current state and thus achieve an optimum measurement result.

In one example, the current temperature is used. However, it can also be measured and updated at regular time intervals and stored in the calculation unit, for example. For example, this is done once per millisecond, once per second or once per minute, or with any other temporal sampling rate.

The calculation unit is set up to calculate a distance by multiplying a measured frequency by a factor, with the measured frequency or distance being multiplied by a compensation factor, in particular a temperature-dependent compensation factor, to calculate a compensated frequency or a compensated distance.

The measuring device according to the invention is set up in such a way that a compensation factor is used whose temperature dependence can be described by a mathematical equation, in particular comprising a linear and a quadratic component.

The compensation function associated with the compensation factor is generated by recording a calibration curve and the coefficients of the compensation function, in particular linear and quadratic coefficients, are derived by an approximation method, in particular minimization of the quadratic deviations.

For the dissipation of the temperature from the calculation unit, for example, at least one circulation unit, in particular a rotor, propellor and/or fan, is used. This provides for a circulation of the air or another gas and thus for a uniform distribution of the temperature inside the module housing. This makes the drift compensation even more precise.

For the purposes of the invention, the term air refers to the mixture of different gases typically associated with ambient air. However, it is also conceivable that another gas mixture and/or a protective gas atmosphere may fill the interior of the housing.

If necessary, an additional circulation unit can be used for heat dissipation at the radar unit.

The circulation units are connected to the calculation unit, for example, and can be controlled by it, in particular also according to the values recorded by the temperature sensor.

In another example, the circulation unit always runs at a constant speed (or a nearly constant speed, deviations less than 5%). This is particularly conducive to a convection process that is as constant as possible. In this way, the temperature in the housing can be as uniform as possible.

For the purposes of the invention, the term circulation unit refers to a unit that helps to homogenize the environmental conditions inside the housing, that is, to make them the same or very similar throughout the volume of the housing. Thus, another example of a circulation unit represents, for example, a unit that allows air exchange and/or gas exchange in a closed loop inside the housing, wherein the air and/or gas that is inside the housing is conveyed by means of a pump in a closed loop and is thus exchanged.

It should be emphasized here that the circulation unit should not be understood primarily as a unit for cooling the interior of the housing, in particular the calculation unit and/or the radar unit. This is because cooling requires the supply of fresh, colder air from outside the housing and the removal of the heated air from inside the housing. This exchange is not possible with a housing that is hermetically sealed off and/or a housing that is lockable in the process. The use of the circulation unit inside the hermetically sealed off and/or lockable housing therefore aims to create as homogeneous a distribution as possible of the environmental factors and the physical parameters to be determined by the detection unit, in particular the temperature, the humidity, the air pressure and/or the supply voltage, particularly preferably the temperature and the humidity.

The creation of homogenized ambient conditions inside the housing and, at the same time, efficient cooling can also be achieved in a hermetically sealed housing if an external supply unit is provided for supplying air, particularly preferably colder air, especially filtered colder air, and/or an external discharge unit is provided for discharging the heated air. A system is hermetically sealed off if it is closed off directly at the point of use from external factors, in particular from an exchange of air, water and/or dirt. Such a supply unit and/or discharge unit can be provided, for example, by arranging hose systems that discharge and/or supply air to and/or from a position from and/or into the housing, which position is provided remote from the housing or its place of use. This has the advantage that, on the one hand, air, in particular pre-tempered air at a defined temperature, can be supplied to the housing and, on the other hand, the air supplied to the housing is not taken up directly at the place of use and can thus, for example, be cleaned before being supplied, in particular by an air purification device arranged in the feed direction, such as, for example, a filter unit, and/or cooled, for example by a cooling device arranged in the feed direction.

The circulation unit associated with the device according to the invention is arranged in the housing in such a way that an air flow or gas flow is produced which transports air or gas from the sensor/receiver to the detection device, in particular the circulation unit being directed on the gas outlet side towards the sensor/receiver and the detection device being arranged downstream of the sensor/receiver with respect to the gas flow direction, or the circulation unit being directed on the gas inlet side or the gas outlet side towards the sensor/receiver and being directed on the gas outlet side towards the detection device with respect to the gas flow direction, or on the suction side to the sensor/receiver and on the gas outlet side to the detection device with respect to the gas flow direction, or the circulation unit is directed on the gas inlet side or on the suction side to the detection device and the detection device is arranged upstream of the sensor/receiver with respect to the gas flow direction, in particular wherein the circulation unit, the sensor/receiver and the detection device are arranged essentially on a connecting line, in particular wherein the sensor/receiver has at least one preferred direction through which gas can flow particularly easily and without resistance, and wherein this direction faces the circulation unit and/or the detection unit.

Heat dissipation by convection from the surface is one of the most favorable options and, in addition to dissipation, provides uniform distribution and thus a more accurate measure of temperature.

The housing of the measuring device can reduce heat transport. For this purpose, it can, for example, be made completely or partially of a material which is suitable for preventing the effect of electromagnetic radiation in the infrared range on the measuring device, in particular for absorbing and/or reflecting electromagnetic radiation in the infrared range or in the range of heat radiation, but not transmitting it or transmitting it only to a small extent. For example, less than 90%, 95%, 98%, or 99% of the incident irradiation is transmitted. In another example, less than 90%, 95%, 98%, or 99% of the incident irradiation is absorbed. These two properties may also be present simultaneously, i.e., in combination, in yet another example. This design measure can reduce temperature fluctuations and their effect on the measurements. The selection of suitable material for the housing represents a passive and thus energy-saving possibility for temperature control, in particular the control of the temperature inside the measuring device. By shielding the infrared radiation, the influence of environmental temperature fluctuations on the measurement and calculation units inside the measuring instrument is reduced, which allows more accurate measurement results to be obtained.

The material used for the housing of the measuring device, in particular the material of the cover plate, is designed to transmit electromagnetic irradiation in the radio frequency range, i.e. it has a low dielectric constant, in particular a dielectric constant or dielectric constant number close to 1.

The housing of the measuring device is arranged in such a way that it comprises a material which is suitable for transmitting an electromagnetic irradiation in the radio frequency range, in particular a material with a low dielectric constant, in particular with a dielectric constant less than 3, in particular with a dielectric constant less than 2.5, in particular with a dielectric constant less than 2.3, in particular in the region of an entrance opening and/or outlet opening for electromagnetic waves and/or a lens

In one embodiment, the housing of the measuring device is made of a material comprising a ceramic and/or PTFE and/or metal. The metal or ceramic housing includes a hole for the transmission of electromagnetic waves in the radio frequency range. This hole is covered or closed with a material comprising PTFE and/or ceramic. By closing the housing with a material through which electromagnetic irradiation in the radio frequency range can be transmitted, the hermetic sealing of the housing is maintained. Besides the advantages of a constant atmosphere inside the measuring instrument, there are further advantages, for example the possible use of the measuring instrument in a dirty and/or dusty environment, whereby the inside of the measuring instrument is not affected.

In an embodiment example, the material of the housing comprises a ceramic and/or a Teflon/PTFE and/or a HDPE/PEHD and/or a metal, wherein in particular a metal and/or ceramic housing, in particular steel housing, stainless steel housing or aluminium housing, is provided, in particular comprising an inlet and/or outlet opening for electromagnetic waves and/or a lens, wherein in particular the inlet and/or outlet opening for electromagnetic waves and/or the lens is formed and/or covered by a material comprising ceramic/Teflon/PTFE/HDPE/PEHD.

For the detection of physical parameters, in particular the detection of the temperature inside the housing of the measuring device, a capacitor, in particular a polymer capacitor, can be used, for example. This provides a reliable possibility for temperature detection. However, the polymer capacitor is to be understood merely as an example.

Redundant measurement is also possible, especially with measurement technologies/sensor technologies of different types in combination. This again increases the measurement accuracy.

Furthermore, in another embodiment, the measuring device may comprise a second sensor, in particular temperature sensor and/or irradiation sensor, which is arranged on the exterior of the housing and is arranged to measure an exterior temperature and/or irradiation incident on the housing from the exterior in order to predict a future development of the at least one physical parameter inside the housing, in particular by means of a temperature development, in particular by temporal extrapolation.

The individual sensor technologies have advantages. For example, a thermoelement responds quite quickly, so is not very inert. On the other hand, a sensor based on a variable resistor is usually extremely accurate, but brings with it a certain inertia/response time.

Another or different physical parameter to be detected can be, for example, the humidity of the air. In particular, the measuring device comprises a sensor for measuring the air humidity, for example a capacitive sensor or a sensor based on the measurement of electrical conductivity. This sensor measures the air humidity, in particular the relative air humidity, inside the housing of the measuring device and sends the values to the calculation unit. The composition of the air or other gas that surrounds the calculation unit and the radar sensor inside the measuring device has an influence on the electromagnetic waves, especially on the electromagnetic waves in the radio frequency range of the radar sensor frontend. These influences can be compensated by means of recording by a humidity sensor and calculation of the compensation by the calculation unit.

Another or different physical parameter to be detected for drift compensation can be, for example, the pressure, in particular the pressure of the air or other gas inside the housing. The pressure of the air or other gas, which surrounds the calculation unit and the radar sensor inside the measuring device, has an influence on the electromagnetic waves, especially on the electromagnetic waves in the radio frequency range of the radar sensor frontend. These influences can be compensated by means of recording by a pressure sensor and calculation of the compensation by the calculation unit.

Another physical parameter to be detected for drift compensation is the supply voltage of the radar unit. Due to, for example, fluctuations in the temperature inside the housing, but also due to aging, the supply voltage of the radar unit can be subject to fluctuations which have an influence on the measurement accuracy. By monitoring the supply voltage, especially by means of a voltage measurement, these fluctuations can be monitored and their influence can be calculated and compensated by the calculation unit.

The consideration of several physical parameters has synergistic effects. For example, the detection and consideration of several physical parameters, e.g. pressure, temperature AND humidity together or quasi simultaneously, reduces the measurement inaccuracy again, not only linearly, but more strongly.

Stronger can mean a quadratic, cubic or exponential reduction of the measurement accuracy. The exact reduction of the measurement accuracy depends on the relation between the measurement result and the physical parameters which are taken into account.

This can be achieved, for example, by detection and consideration and detection of pressure and temperature.

This can be achieved, for example, by detection and consideration and detection of humidity and temperature.

This can be achieved, for example, by detection and consideration and detection of pressure and humidity.

This can be achieved, for example, by detecting and considering and detecting pressure, temperature and humidity.

The calculation unit, which is located inside the housing, is responsible for the evaluation of the radar sensor measured signal. Furthermore, it calculates the compensation of the signal drifts. This ensures a simple application of the measuring device for the user, since the signals do not have to be processed further.

The calculation unit can be provided digitally or analog or as a combination of digital and analog technology. In particular, the compensation can be performed digitally or also by means of analog circuits.

For example, the calculation unit records the physical values, in particular the air or gas pressure inside the housing, the temperature inside the housing and/or the calculation unit, or the oscillation frequency and/or natural frequency of the oscillator of the radar unit and/or the humidity. One or more of these physical measures can be used to calculate the drift compensation of the radar measurements. As a result, high accuracy of the radar measurement unit can be performed regardless of its age, its physical environmental values, or its internal physical values. For the calculation, an oscillation frequency and/or natural frequency of the oscillator of the radar unit and an environmental value, in particular an ambient temperature and an oscillation and/or natural frequency of the sensor or receiver can be detected in combination. By calculating the compensation from two or more influencing variables instead of one influencing variable, a higher accuracy of the measured signal is achieved. Modern computing technology makes it possible to calculate the measured signal accurately.

For the compensation, the calculation unit can, for example, be able to extrapolate the temporal course of the temperature. Predictions about the temperature development are thus possible. This makes drift compensation even more accurate and the measures more precise. In addition, computing resources can be used sparingly and optimally distributed over time.

In a further embodiment, the calculation unit can cause the parameters of the radar unit to be changed, for example, the calculation unit can adjust the transmission and reception parameters of the radar unit on the basis of measured physical parameters in such a way that the latter compensates for a change in the physical values of the environment, in particular the air pressure or gas pressure inside the housing, the temperature inside the housing and/or the calculation unit, or the oscillation frequency and/or natural frequency of the oscillator of the radar unit and/or the humidity. Advantageously, a higher measurement accuracy can be achieved without the need for additional calculation and/or processing of the measuring data.

Also feasible is an embodiment in which the calculation unit comprises a computer readable storage medium. The computer readable storage medium contains a data set which contains influencing factors for different environmental influences which are used for drift compensation. The calculation unit is arranged to access the influencing factors by instructions of a computer program product also stored on the computer readable storage medium, and to compute them with the currently measured values for the physical parameters in order to correct the obtained measures of the radar unit for the drift created by the physical parameters.

In one embodiment, sensors may also be attached to the exterior of the measuring device. The sensors can measure either the temperature and/or the irradiation. Based on the temperature and/or the irradiation incident on the housing, a prediction can be made about the temperature development inside the housing.

In one embodiment, a circulation unit is used for heat transport or heat dissipation at the radar frontend, which guides the air or other gas over a temperature sensor. This provides reliable measurement of temperature and/or improved circulation of the air or other gas inside the housing. Alternative arrangements may include, for example, positioning the fan between the radar sensor frontend and the temperature sensor, or positioning the fan behind the radar sensor frontend and the temperature sensor, as viewed in the gas flow direction. Basically, there should be an overflow of the temperature sensor with the gas heated by the radar sensor frontend. This ensures an effective overflow of the sensors and thus good detection of the temperature.

In one embodiment, the calculation unit comprised by the measuring device comprises a cooling unit, in particular comprising at least one fan, propellor or rotor, which in particular is different from the circulation unit, wherein in particular the fan, propellor or rotor and the circulation unit, with respect to their respective air outlet or gas outlet, assume an angle of between 30 and 150 degrees, further in particular between 45 and 135 degrees, further in particular between 60 and 120 degrees, further in particular between 80 and 100 degrees.

In one embodiment, at least one additional fan, propellor or rotor is used for heat dissipation from the calculation unit, which in one example may be different from the circulation unit. For example, the air or gas flow of the heat dissipation takes an angle between 30° and 150° or 45° and 135° or 60° and 120° or 80° and 100° with respect to the air or gas flow of the circulation. This arrangement provides a high degree of turbulence and thus a high degree of mixing of the heat flow and the circulation flow, and thus a uniform distribution of the temperature of the atmosphere inside the measuring device.

According to the invention, a method for measuring distances with compensation of a signal drift is also provided.

In this context, the method for measuring a measure, in particular a distance, in particular a distance of one or more objects to be measured, and/or a signal intensity, in particular signal intensity correlating with a size and/or quantity of one or more objects to be measured, with compensation of a drift behavior, in particular a temperature-dependent drift behavior, in particular using a measuring device for electromagnetic waves, further in particular a radar apparatus, comprises at least the following steps:
Detection (S01) of at least one physical parameter in a housing (1, 2, 11, 12), in particular a hermetically sealed off and/or lockable housing, in which a sensor and/or receiver (4) for electromagnetic waves is arranged, the at least one physical parameter comprising a physical parameter of the environment, in particular a temperature, in particular an ambient temperature, in particular a temperature of an ambient air in the housing (1, 2, 11, 12), and/or a current oscillation frequency and/or natural frequency of an oscillator, in particular of an oscillator of the sensor or receiver (4), respectively receiver (4) for electromagnetic waves,
Obtaining (S02), in particular calculating or reading from a database, a compensation and/or compensation function and/or a compensation factor on the basis of the at least one physical parameter, in particular a compensation and/or compensation function which is suitable for compensating, on the basis of the at least one physical parameter, a measuring error caused by an environmental parameter and/or environmental influence on a measurement result which is based at least in part on a sensor and/or receiver (4) for electromagnetic waves.

In another embodiment, the method further comprises the following steps:
Reception (S04) of a signal in the form of an electromagnetic wave, in particular in the form of an electromagnetic wave in the radio frequency range,
Compensating (S05) the received signal and/or a measure determined on the basis of the received signal on the basis of the calculated compensation and/or compensation function to obtain a compensated signal, in particular compensating on the basis of the at least one physical parameter, in particular compensating for effects of temperature and/or an oscillation and/or natural frequency of an oscillator and/or an effect of aging of an oscillator.

In another embodiment, the method further comprises the following step:
Initiating (S10) circulation of ambient air or ambient gas in the housing and/or temperature compensation in the housing, in particular by means of a movable element, in particular by rotationally operating a rotatable device, in particular a rotor, propeller and/or fan, the movable element being arranged in the housing and being set up to effect circulation of ambient air or ambient gas in the housing and/or to promote temperature compensation in the housing.

In another embodiment, the method further comprises the following step:
Transmission (S03) of a signal in the form of an electromagnetic wave, in particular in the form of an electromagnetic wave in the radio frequency range, in particular by means of a transmitter and/or transceiver, wherein furthermore in particular the transceiver is identical with the sensor and/or receiver.

According to an embodiment, the method for measuring distances with compensation of a signal drift using the present measuring device comprises the following steps:
a) Detection of at least one physical parameter in the housing of the measuring device, which may be a temperature, in particular an ambient temperature, and/or a pressure and/or a humidity and/or a current frequency of an oscillator, in particular an oscillator of a sensor or receiver for electromagnetic waves.
b) Calculate the compensation and/or compensation function of a measuring error based on the environmental values recorded in step 1.
c) Reception of a signal in the form of an electromagnetic wave in the radio frequency range.
d) Compensating the measuring error of the signal received in step 3 using the compensation and/or compensation function calculated in step 2.

For temperature compensation inside the housing of the measuring device, for example, a circulation flow of air or another gas can be initiated with a movable element. The movable element can in particular be a rotor, propellor or fan.

According to the invention, in addition to a distance, for example, a measured signal intensity can also be compensated. Several variables, for example distance and signal intensity, can also be compensated simultaneously.

It can be compensated on the basis of one temperature, another parameter, or even several parameters simultaneously, for example including one temperature.

All combinatorial possibilities of measures to be compensated on the one hand, and physical parameters on the basis of which compensation is performed, are amenable to use within the scope of an embodiment of the present invention.

For example, in a radar use case, a signal intensity may be proportional to an area of one or more objects facing the sensor and/or receiver. For example, this signal intensity correlates with a size or quantity of one or more measured objects.

Thus, the device according to the invention and the method according to the invention provide a drift-compensated measure which has been provided by a measuring device for electromagnetic waves or has been created on the basis of a method as explained above, in particular a drift-compensated measure of a measured distance, in particular with compensation of a temperature-dependent drift behavior.

For specific measurement and compensation examples as well as exemplary compensation data, please refer to the figure descriptions.

The features disclosed in the present document in connection with the apparatus can in any case also be used in connection with the method. This also applies vice versa, and likewise to drift-compensated measuring data and programs for computers according to the invention.

### DESCRIPTION OF THE FIGURES

[symbol] A schematic overall view of the measuring device

[symbol] An explosion drawing of the measuring device

[symbol] A schematic representation of the electronic components as a

[symbol] A schematic view of the interior of the housing body 11, with the fan 8 positioned between the radar sensor frontend 8 and the temperature sensor

FIG. 5 A schematic view of the interior of the housing body 11, temperature sensor 5 is located between the fan 8 and the radar sensor frontend 4.

FIG. 6 A plot of the temperature profile over time during a measurement period

FIG. 7 A plot of the measured distances over time during a measurement period, showing the compensated and uncompensated measure

FIG. 8 A plot of the measured distance over time during a measurement period, showing the compensated measure

FIG. 9 A plot of measured signal intensity versus time during a measurement period, showing compensated and uncompensated signal intensity

FIG. 1 shows an overall view of an embodiment of the measuring device. The housing body 11 is closed at the back by the housing cover 12 and at the front by the housing front panel 1. The recess in the housing front panel 1 is closed by the cover plate 3. The cover plate 3 is designed to be permeable to the electromagnetic waves in the radio frequency range of the radar unit, here radar sensor frontend 4 in FIG. 2 and FIG. 3. The housing front panel 1, the housing body 11 and the housing cover 12 are designed to absorb electromagnetic waves in the infrared range.

FIG. 2 shows an explosion drawing of an embodiment of the measuring device. The seals 2 enable the housing to be hermetically sealed. Behind the cover plate 3 the radar sensor frontend 4 is arranged, which contains transmitter and receiver. The air or gas located around it is moved by a circulation unit, referred to here as fan 8. Further fans 8 are located above the calculation unit 9. The fans 8, the radar sensor frontend 4, by means of connection cable radar sensor frontend 6, and the temperature sensor 5, by means of connection cable temperature sensor 7, are connected to the calculation unit 9.

FIG. 3 shows an embodiment of the electronic components as a unit. Here, the calculation unit 9 is mounted directly on the radar sensor frontend 4. A fan 8 allows air or gas to flow through the radar sensor frontend 4 via a temperature sensor 5, which is also connected to the calculation unit 9. The network and power cable 10 leads from the calculation unit out of the housing through the housing cover 12.

In FIG. 4, the fan 8 is arranged between the radar sensor frontend 4 and the temperature sensor so that the air flow attracted by the fan 8 via the radar sensor frontend 4 is blown onto the temperature sensor 5.

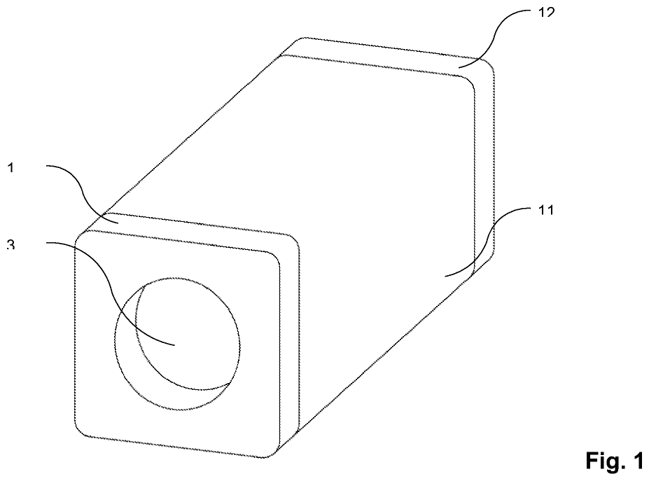

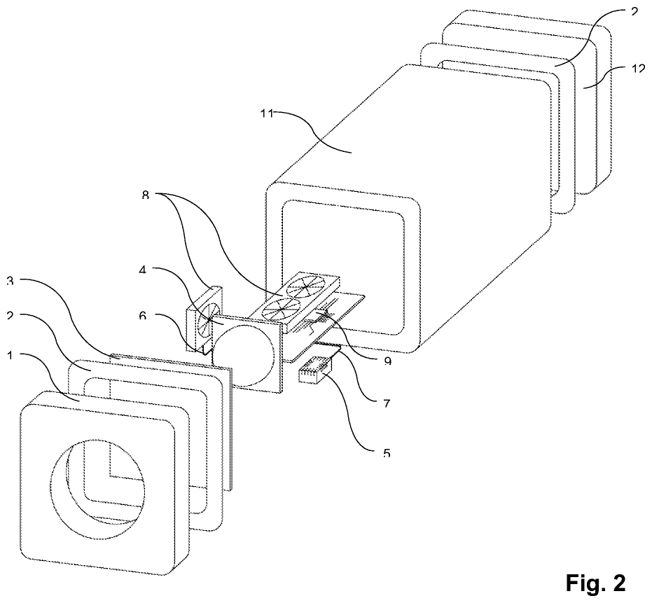

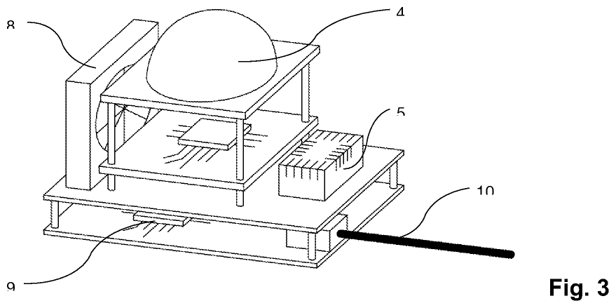

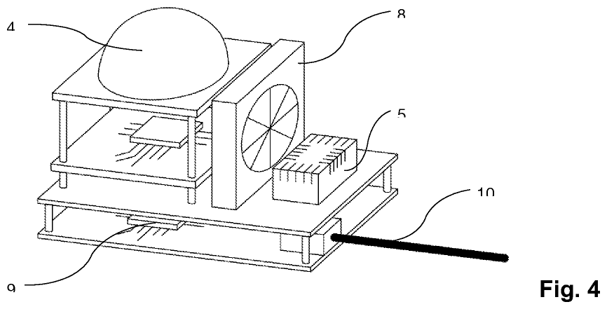

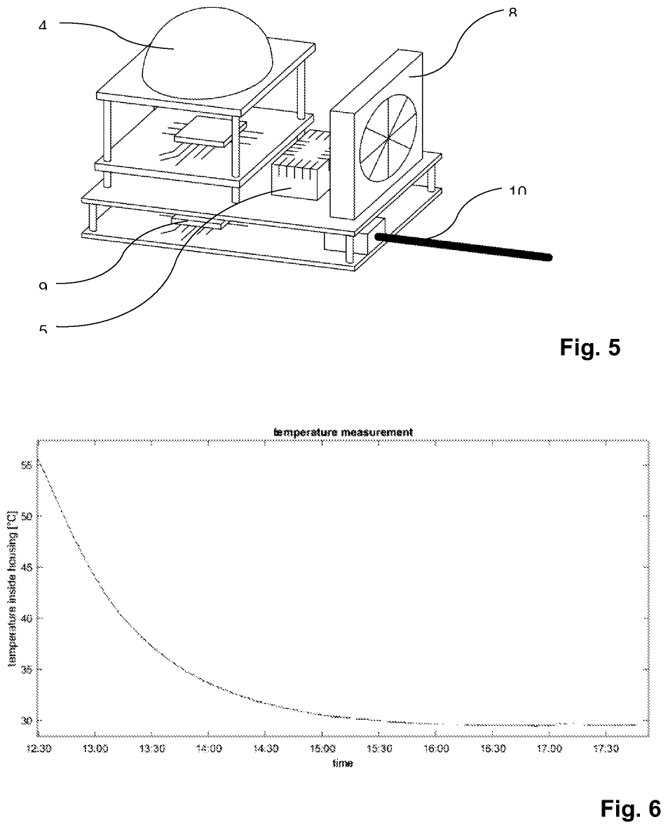

In FIG. 5, the temperature sensor 5 is located between the fan 8 and the radar sensor frontend 4. The air flow attracted by the fan 8 is first drawn over the radar sensor frontend 4 and then over the temperature sensor 5.

FIG. 6 shows the temperature profile during a test case.

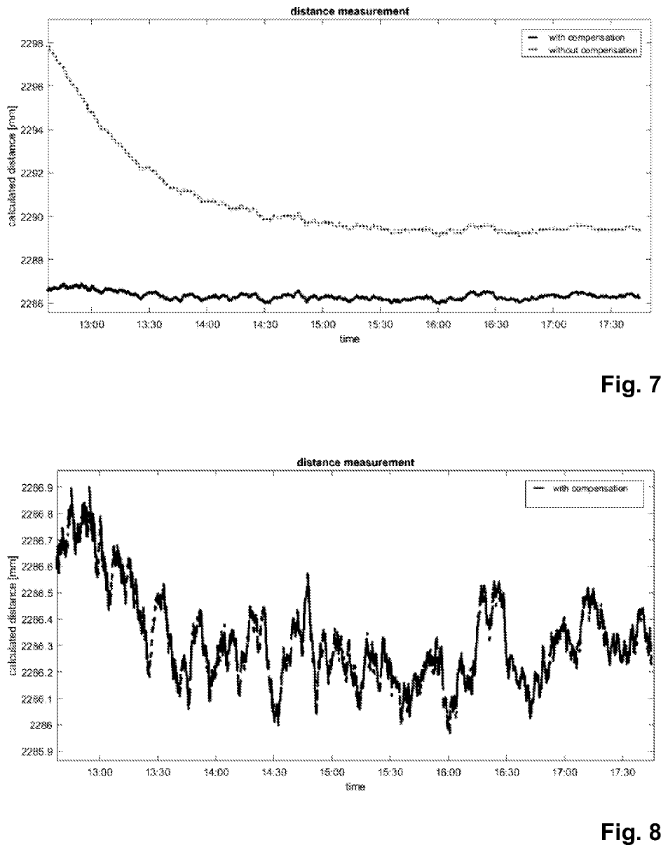

The distances measured are shown in FIG. 7. A correlation is clearly visible, since the uncompensated curve is similar to the temperature curve, whereas the compensated curve is not affected by the temperature change thanks to the use of the present invention. As the temperature decreases, the measured value decreases.

This compensated measure, a distance, is plotted against time and shown in FIG. 8.

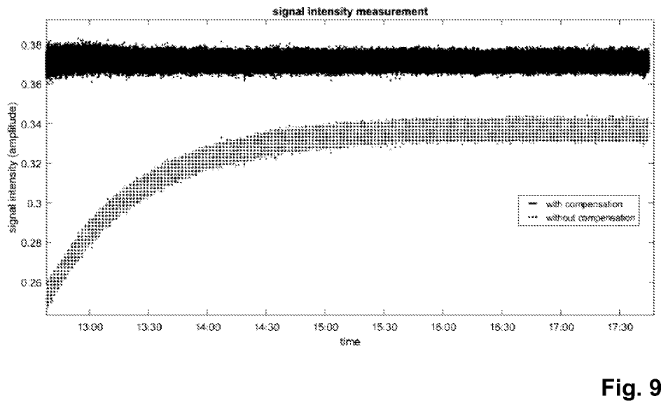

A similar temperature effect can be seen in FIG. 9, where the measured signal intensity is shown compensated and uncompensated over time. Here, by virtue of the present invention, the intensity in the compensated state behaves essentially independently of temperature, whereas the uncompensated intensity shows a strong temperature dependence. Namely, as the temperature inside the measuring device decreases, the measured uncompensated signal intensity increases significantly.

The invention thus provides access to significantly more accurate measures that correspond much more precisely and independently of the internal conditions of the measuring device to the actual measurands being measured.

The measurement curves shown in FIGS. 6-9 show real measurement results of test series actually carried out.

### BIBLIOGRAPHY

[Brau] CA Pat. No. 2483971; U.S. Pat. No. 7,209,072B2; Method for drift compensation with radar measurements with the aid of reference radar signals; https://patentimages.storage.googleapis.com/f1/f9/d6/df775305c4e85e/CA2483971C.pdf; https://patentimages.storage.googleapis.com/15/3d/5e/8683997265fecb/U.S. Pat. No. 7,209,072.pdf
[Brown] U.S. Pat. No. 5,454,270; Hermetically sealed pressure sensor and method thereof; https://patentimages.storage.googleapis.com/d8/4e/77/eaf7e6c4444677/U.S. Pat. No. 5,454,270.pdf
[Corey]U.S. Pat. No. 6,243,040B1; Hermetic package with external patch antenna and associated method; https://patentimages.storage.googleapis.com/e8/0e/8f/2258409b362808/U.S. Pat. No. 6,243,040.pdf
[Waterproof temperature sensor; https://www.directindustry.com/industrial-manufacturer/waterproof-temperature-sensor231651.html
[Ein] Ocillator Clock Drift Compensation in Bistatic Interferometric SAR; Eineder, Michael; 2003; DOI: 10.1109/IGARSS.2003.1294140.
[Fra] DE Pat. 10 2018 205 670 A1; Hermetically sealed module unit with integrated antennas; https://patentimages.storage.googleapis.com/90/b8/69/100387077e59d4/DE102018205670A1.pdf
[John] U.S. Pat. No. 4,106,020; FM-CW radar ranging system; https://patentimages.storage.googleapis.com/45/5f/d0/b11eed7c10ad5c/U.S. Pat. No. 4,106,020.pdf
[Kav] P5000 Hermetically Sealed High Pressure Sensor; http://www.konkurel.ru/kavlico/pdf/P5000_Kavlico.pdf
[Kipp] U.S. Pat. No. 4,435,712A; FM-CW radar ranging system with signal drift compensation; https://patentimages.storage.googleapis.com/68/71/92/f04819f231891d/U.S. Pat. No. 4,435,712.pdf
[Mic] HermeSeal—Hermetically Sealed Infrared Compinents by Micro-Hybrid; https://www.sensortest.de/ausstellerbereich/upload/mnpdf/en/Produktvorstellung_HermeSeal EN_14.pdf
[Omega] Flexible Sealed PFA RTD Sensors; https://br.omega.com/omegaFiles/temperature/pdf/HSRTD.pdf
[rad] https://www.radartutorial.eu/07.waves/Frequenz-%20und%20Wellenbereiche.de.html
[Runge] EU Pat. No. 1065518A2; Hochauflösendes Synthetik-Apertur-Radarsystem; https://patentimages.storage.googleapis.com/e2/26/b1/854a3d9de60844/EP1065518A2.pdf
[Sch] U.S. Pat. No. 7,180,440B2; Integrated circuit for a radar device in a hermetically sealed housing comprising a path antenna formed from a bent component of sheet metal; https://patentimages.storage.googleapis.com/29/da/87/27b17af8c15a28/U.S. Pat. No. 7,180,440.pdf
[Sche] Dissertation: FMCW-Radarsignalverarbeitung zur Entfernungsmessung mit hoher Genauigkeit; Scherr, Steffen; 2016.
[Tosh03] EU Pat. No. 1357395A1; Miniaturized and hermetically sealed radar sensor for millimeter wave signals; https://patentimages.storage.googleapis.com/83/13/c8/101a04f6c5b4e0/EP1357395A1.pdf
[Tosh07] EU Pat. No. 1357395B1; Radarsensor; https://patentimages.storage.googleapis.com/d9/bd/8b/a05af13dd16357/EP1357395B1.pdf
[Wiki] https://de.wikipedia.org/wiki/Hermetischer_Verschluss
[U.S. Pat. No. 6,236,366B1; Hermetically sealed semiconductor module composed of semiconductor integrated circuit and antenna element; https://patentimages.storage.googleapis.com/d9/32/64/92768e3e2f2d3f/U.S. Pat. No. 6,236,366.pdf

### LIST OF REFERENCE SIGNS

1. housing front panel
2. seal (2×)
3. cover plate (ceramic/PTFE)
4. radar sensor frontend
5. temperature sensor
6. connection cable radar sensor frontend
7. connection cable temperature sensor
8. fan
9. calculation unit
10. network cable and power cable
11. housing body
12. housing cover

1. A measuring device for electromagnetic waves for a measurement of a measure and/or a signal intensity with compensation of a drift behavior comprising:
a hermetic sealed off and/or lockable housing (1, 2, 11, 12),
a sensor and/or receiver (4) for electromagnetic waves, which is arranged in the hermetically sealed off and/or lockable housing (1, 2, 11, 12), comprising an oscillator,
a detection device (5), characterized in that it is arranged in the hermetically sealed off and/or lockable housing (1, 2, 11, 12), wherein the detection device for detecting
of at least one physical parameter and/or
a current oscillation and/or natural frequency of an oscillator is set up.

2. The measuring device of claim 1, further comprising a circulation unit (8), wherein the circulation unit (8) is arranged in the housing, and is adapted to effect circulation of ambient air or ambient gas in the housing and/or to promote temperature compensation, air humidity compensation and/or pressure compensation and/or uniform distribution of environmental factors in the housing.

3. The measuring device of claim 1, wherein the housing comprises a material suitable for protecting against an effect of electromagnetic irradiation in the infrared range on the measuring device.

4. The measuring device of claim 1, wherein the housing comprises a material suitable for transmitting electromagnetic irradiation in the radio frequency range.

5. The measuring device of claim 3, wherein the material comprises a ceramic and/or Teflon/PTFE and/or HDPE/PEHD and/or comprises a metal, wherein a metal housing and/or ceramic housing is provided comprising an electromagnetic wave inlet and/or outlet opening and/or a lens, wherein the electromagnetic wave inlet opening and/or outlet opening and/or the lens is formed and/or covered by a material comprising ceramic/Teflon/PTFE/HDPE/PEHD.

6. The measuring device of claim 1, wherein the detection device comprises a capacitor and/or a thermoelement and/or a thermal imaging camera and/or a variable resistor, individually or in combination, as a measuring element for a physical parameter.

7. The measuring device of claim 6, wherein the detection device is adapted to detect a temperature and/or an air humidity as physical parameters.

8. The measuring device of claim 1, wherein the at least one physical parameter comprises a pressure.

9. The measuring device of claim 1, wherein the at least one physical parameter comprises a voltage, the voltage being the supply voltage of the radar unit.

10. The measuring device of claim 1, further comprising a calculation unit which is set up to compensate for drift behavior or to take it into account by calculation.

11. The measuring device of claim 10, wherein the calculation unit is arranged to compensate for or computationally take into account the drift behavior based on a detected physical parameter of the environment and/or a current oscillation frequency and/or natural frequency of an oscillator.

12. The measuring device of claim 10, wherein the calculation unit is arranged to further take into account a temporal development and/or tendency when compensating or calculating.

13. The measuring device of claim 1, wherein the calculation unit is adapted to perform an adjustment of the measuring parameters of the radar unit based on at least one physical parameter.

14. The measuring device of claim 1, further comprising a second sensor arranged on the exterior of the housing and adapted to measure an exterior temperature or irradiation incident on the housing from the exterior to predict a future evolution of the at least one physical parameter inside the housing.

15. The measuring device of claim 10, wherein the calculation unit is arranged to calculate a distance by multiplying a measured frequency by a factor, wherein the measured frequency or distance is multiplied by a compensation factor to calculate a compensated frequency or distance, respectively.

16. The measuring device of claim 15, wherein a compensation factor is used whose temperature dependence can be described by a mathematical equation.

17. The measuring device of claim 16, wherein the compensation function is generated by recording a calibration curve and the coefficients of the compensation function are derived by an approximation method.

18. The measuring device of claim 2, wherein the circulation unit is arranged in the housing in such a way that an air flow or gas flow is created which transports air or gas from the sensor/receiver to the detection device.

19. The measuring device of claim 9, wherein the calculation unit comprises a cooling unit.

20. The measuring device of claim 1, further comprising an electromagnetic wave transmitter and/or emitter different from the electromagnetic wave sensor and/or receiver and arranged to emit a signal in the form of an electromagnetic wave and/or whose electromagnetic wave sensor and/or receiver is further arranged as a transmitter and/or emitter.

21. The measuring device of claim 1, further comprising an electromagnetic wave transmitter and/or emitter distinct from the electromagnetic wave sensor and/or receiver and adapted to emit a signal in the form of an electromagnetic wave, the measuring device further comprising:
a housing of the transmitter, wherein the electromagnetic wave transmitter and/or emitter is arranged in the housing of the transmitter,
a detection device of the transmitter, which is arranged in the housing of the transmitter, for detecting at least one physical parameter in the housing of the transmitter, the measuring device being arranged to drive drift compensation on the basis of the physical parameter in the housing of the transmitter, compensating at the received signal on the basis of the physical parameter in the housing of the transmitter.

22. The measuring device of claim 1 for a measurement of a distance of an object with compensation of a drift behavior wherein a measured distance and/or a frequency measured for determining the distance is compensated.

23. The measuring device of claim 1 for measuring a signal intensity, wherein the signal intensity correlates with a size and/or quantity of one or more objects and/or with a size and/or area of a surface facing the sensor or receiving device, with compensation of a drift behavior in said signal intensity, wherein a measured signal intensity and/or a measured size and/or quantity of one or more objects and/or an area of a surface facing the sensor or receiving device is compensated.

24. A method for measuring a measure, in particular a distance with compensation of a drift behavior, at least comprising the following steps:
Detection (S01) of at least one physical parameter in a housing (1, 2, 11, 12) in which a sensor and/or receiver (4) for electromagnetic waves is arranged, the at least one physical parameter comprising a physical parameter of the environment and/or a current oscillation frequency and/or natural frequency of an oscillator,
Obtaining (S02) a compensation and/or a compensation function and/or a compensation factor which is suitable for compensating, on the basis of the at least one physical parameter, to compensate a for a measuring error and/or environmental influence on a measurement result which is based at least in part on a sensor and/or receiver (4) for electromagnetic waves.
Reception (S04) of a signal in the form of an electromagnetic wave,
Compensating (S05) the received signal and/or a measure determined based on the received signal based on the calculated compensation and/or compensation function to obtain a compensated signal.

25. The method of claim 24, further comprising the step of:
Initiating (S10) a circulation of ambient air or ambient gas in the housing and/or a temperature compensation in the housing by means of a movable element, wherein the movable element is arranged in the housing and is set up to effect a circulation of ambient air or ambient gas in the housing and/or to promote a temperature compensation in the housing.

26. The method of claim 24, further comprising the step of:
Sending (S03) a signal in the form of an electromagnetic wave.

27. A drift-compensated measure provided by the electromagnetic wave measuring device of claim 1 or created based on the method of claim 24.

28. Computer-program A computer program suitable for causing a computer to perform the method of claim 24.

29. A computer readable storage medium having a memory area comprising the drift-compensated measure according to claim 27 and/or the computer program of claim 28.
